(19) United States
(12) Patent Application Publication
(10) Pub. No.: US 2014/0004484 A1
(43) Pub. Date: Jan. 2, 2014

(54) Precise Portions Nutrition Control System

(71) Applicants: Ann-Marie B. Austin-Stephens, Richmond, VA (US); Eddy Stephens, Richmond, VA (US); Robin Nwankwo, Ann Arbor, MI (US); Bernadine Shaw-Scott, Detroit, MI (US)

(72) Inventors: Ann-Marie B. Austin-Stephens, Richmond, VA (US); Eddy Stephens, Richmond, VA (US); Robin Nwankwo, Ann Arbor, MI (US); Bernadine Shaw-Scott, Detroit, MI (US)

(21) Appl. No.: 13/930,191

(22) Filed: Jun. 28, 2013

Related U.S. Application Data
(60) Provisional application No. 61/666,802, filed on Jun. 30, 2012.

(51) Int. Cl. G09B 19/00

(52) U.S. Cl. CPC G09B 19/0092
USPC 434/127

(57) ABSTRACT

A system and related method for consumer focused portion control plating and nutritional intake are described. The system includes a variety of dishware and discs with indicia that provide dietary guidance.

### RELATED APPLICATION DATA

This application claims the priority of prior U.S. provisional application Ser. No. 61/666,802 filed on Jun. 30, 2012, which is hereby incorporated by reference herein in its entirety.

### TECHNICAL FIELD

The invention relates to nutrition systems, more specifically to precise portion nutrition control systems.

### BACKGROUND ART

There is a need for a system that teaches consumers on how to eat well and improve their eating habits for life.

### SUMMARY OF THE EMBODIMENTS

The Precise Portions Nutrition Control System of the present invention is the most comprehensive, consumer focused portion control plating & nutrition retraining system in the marketplace. This system is configured to retrain consumers on how to eat well (balanced, proportioned meals) and improve their eating habits for life. This invention will impact childhood and adult obesity, diabetes management and many other food related chronic diseases such as high blood pressure, etc.

The invention features a system for controlling food portion in a meal for optimal nutritional intake, where the system includes:

a) one or more precise portions living tools selected from the group consisting of one or more plates, one or more bowls, and one or more beverage glasses, where one or more of the precise portions living tools have indicia (e.g., names of food, pictures of food, and color codes representing food groups) on the surface of the tool to provide dietary guidelines for selecting an appropriate portion of a food group; and

b) one or more of a precise portions nutrition control system disc that include nutritional information for daily calorie budgeting, daily meal planning, infographics for creating balanced nutritional means, or healthy eating menu plans.

The system can include one or more precise portions learning tools selected from the group consisting of an e-book, hard copy books, interactive teaching videos, maintenance programs, and one or more personal coaching systems. The system can also include a portion control ladle.

The plates of the above system can have a size ranging from 4″ to 10″ in diameter (e.g., 4″, 5″, 6″, 7″, 8″, 9″, and 10″). The plate can be transparent. The plate can also have one or more (e.g., 2, 3, or 4) sections divided by protruded walls on the surface of the plate.

The plates, bowls, and beverage glasses are made of a material selected from the group consisting of porcelain, glass, plastic, tempered glass, ceramic, stoneware, and wood.

In preferred embodiments, the said plates, bowls, and beverage glasses can be microwave safe. The plates, bowls, and beverage glasses can also be dishwasher safe.

The plates, bowls, and beverage glasses can be made of a single use disposable material (e.g., Styrofoam, cardboard, compostable sugarcane, compostable bamboo, and paper). The plates, bowls, and beverage glasses can also be made of an eco-friendly single use disposable material.

The system can also include a travel plate with a ventable lid.

The bowls to be used in the system can have a capacity ranging from 6 oz to 20 oz, e.g., an 18 oz cereal bowl, and an 8 oz snack bowl.

The beverage glass of the system can have a capacity ranging from 2 oz to 15 oz, e.g., a 10.5 oz beverage glass.

Two or more of the precise portions nutrition control system discs (e.g., 3, 4, 5, 6, 7, or more discs) can be hinged together at one pivotal point, such that said two or more discs can rotate around the pivotal point. The discs can encode specific user parameters (e.g., height, weight, blood glucose level, age, and basal metabolic rate) or levels of physical activity of a user (e.g., inactive, active, and very active) to determine a caloric intake specific to that user by aligning two or more discs in a specific position such that one of the discs outputs a caloric intake value based on the user parameters encoded in the other discs.

The invention also features a method for proportioning food groups for optimal nutritional intake using the system of the invention, where the method includes serving specific food groups into one or more precise control portion tools based on the indicia on the surface of the tool to serve the appropriate proportion of specific food groups for optimal nutritional intake.

The method can further include a step of placing a plate (e.g., a transparent plate) on one or more of the precise portions nutrition control system discs to serve food on the plate based on the nutritional information on the disc. The food can be served using a portion control ladle.

The method can further include using a set of precise portions nutrition control system discs attached at a pivotal hinge, where the discs encode specific user parameters (e.g., height, weight, blood glucose level, age, and basal metabolic rate) or level of physical activity (e.g., inactive, active, or very inactive) to determine a caloric intake specific to that user by aligning two or more discs in a specific position such that one of the discs outputs a caloric intake value based on the user parameters encoded in the other discs.

The Precise Portions Nutrition Control System can improve a person's eating habits in 3 simple ways:

Psychologically—retrains a person to consistently eat smaller portions and well-balanced food groups.

Physically—Easy, just stay within the guidelines of the Precise Portions Living Tools and a person now eats healthy with no guesswork, no weighing, and no counting.

Emotionally—consumers feel good again as they build new eating habits and regain personal confidence that they can be disciplined about food. Moms know that with The Precise Portions Nutrition Management System they can actively improve their family's diet and health.

Other aspects, embodiments and features of the invention will become apparent from the following detailed description of the invention when considered in conjunction with the accompanying figures. The accompanying figures are for schematic purposes and are not intended to be drawn to scale. In the figures, each identical or substantially similar component that is illustrated in various figures is represented by a single numeral or notation. For purposes of clarity, not every component is labeled in every figure. Nor is every component of each embodiment of the invention shown where illustration is not necessary to allow those of ordinary skill in the art to understand the invention.

### DEFINITIONS

By “precise portions living tool” is meant a plate, a bowl, or a beverage glass.

By “precise portions nutrition control system disc” is meant a disc that contains nutritional information for daily calorie budgeting, daily meal planning, infographics for creating balanced nutritional means, or healthy eating menu plans.

By “infographics” is meant text and graphics that convey information on nutritional intake of food.

### BRIEF DESCRIPTION OF THE DRAWINGS

The preceding summary, as well as the following detailed description of the invention, will be better understood when read in conjunction with the attached drawings. For the purpose of illustrating the invention, presently preferred embodiments are shown in the drawings. It should be understood, however, that the invention is not limited to the precise arrangements and instrumentalities shown.

FIG. 1 is an example of a portion control plate of the system of the present invention.

FIG. 2 is an illustration of a portion control dishware set in accordance with some embodiments of the present invention.

FIG. 3 is an example of disposable plates in accordance with another embodiment of the present invention. The figure shows protrusions on the surface of the plate that divide the area of the plate into multiple sections.

FIG. 4 illustrates portion control glasses of the system in accordance with the present invention.

FIG. 5 is an illustration of a portion control scoop of the system of the present invention.

FIG. 6 is a schematic of the portion control system disc of the present invention.

FIG. 7 is an example of a portion control system disc with kid friendly motifs and indicia.

FIG. 8 is an example of a portion control plate of the system of the present invention.

FIG. 9 is a schematic of a placemat of the system of the present invention.

FIG. 10 is an illustration of the mascots Portia and Plato of the present invention.

FIG. 11 is an example of a flash card of the system of the present invention.

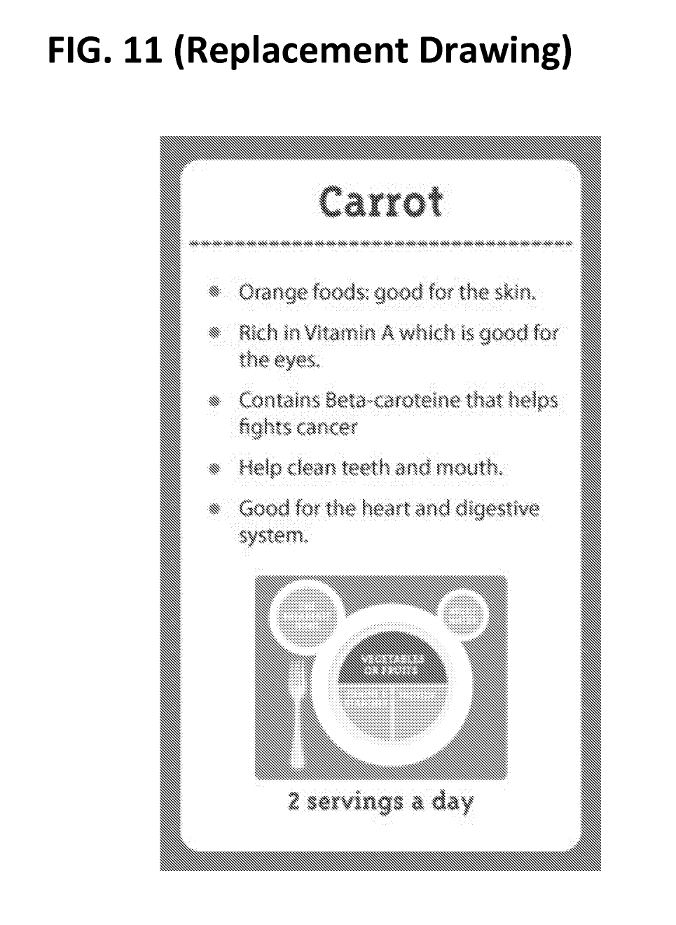

FIG. 12 is an example of multiple discs attached by a pivotal central hinge such that the discs can rotate with respect to one another and be used to calculate caloric intake information based on parameters on discs that are adjusted by the user.

FIG. 13 is an example of a travel system that includes the discs and a divided plate with a ventable lid to fit on top of the plate.

FIG. 14 is an example of a Parents Nutrition Book.

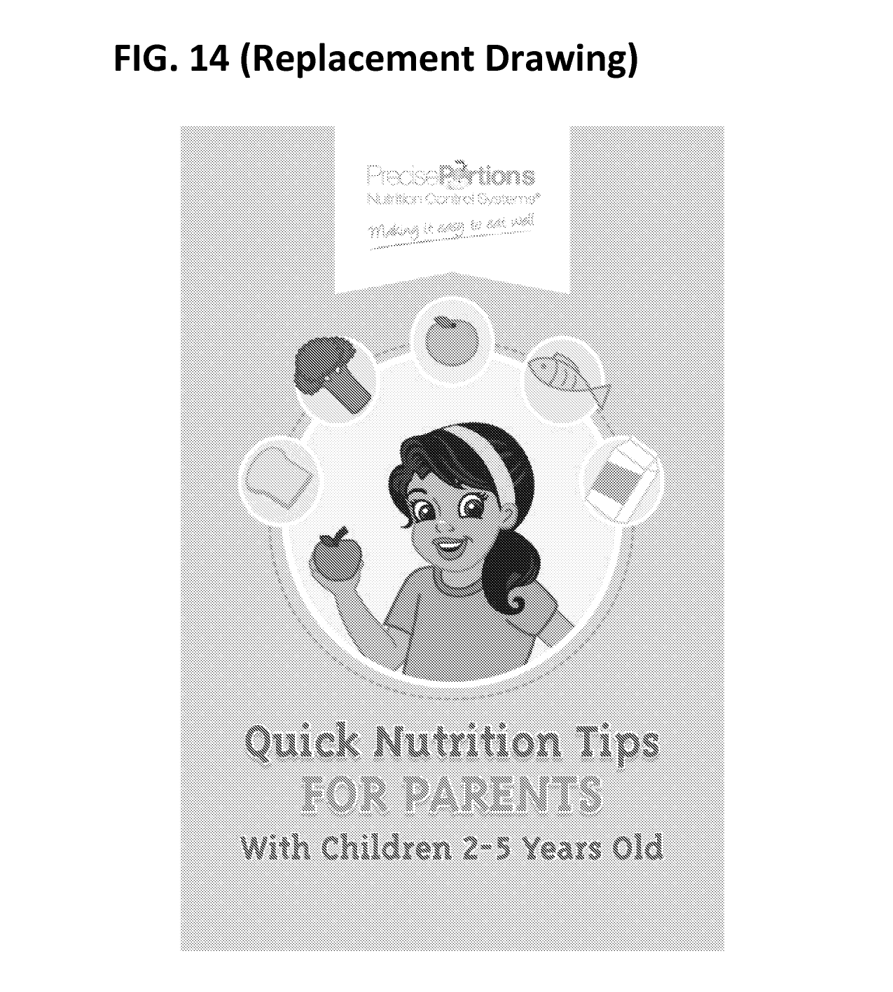

FIG. 15 is an example of a precise portions adult plating system.

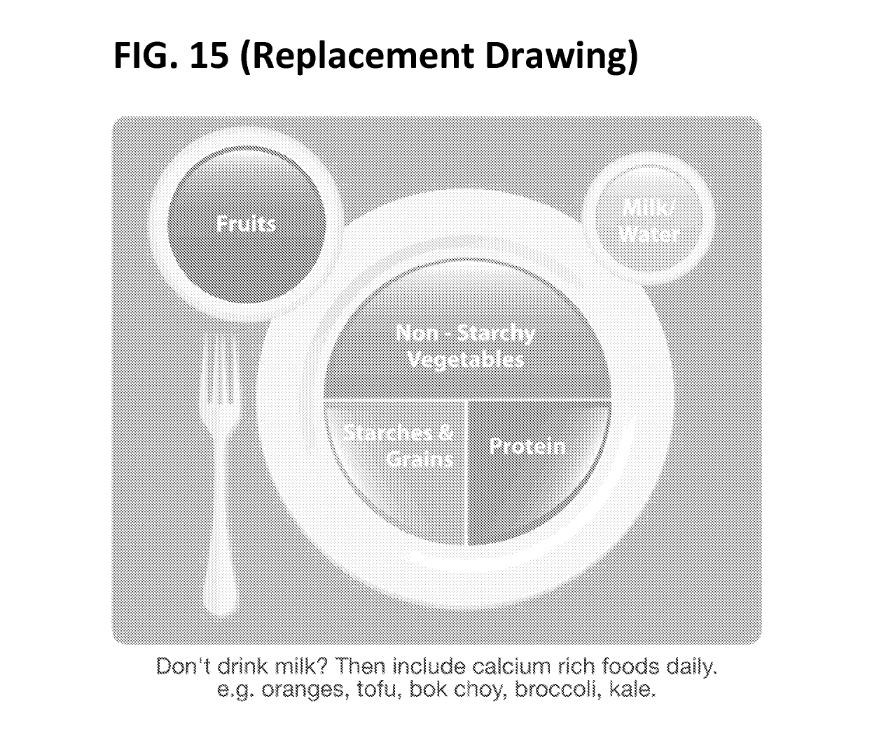

### DETAILED DESCRIPTION OF SPECIFIC EMBODIMENTS

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

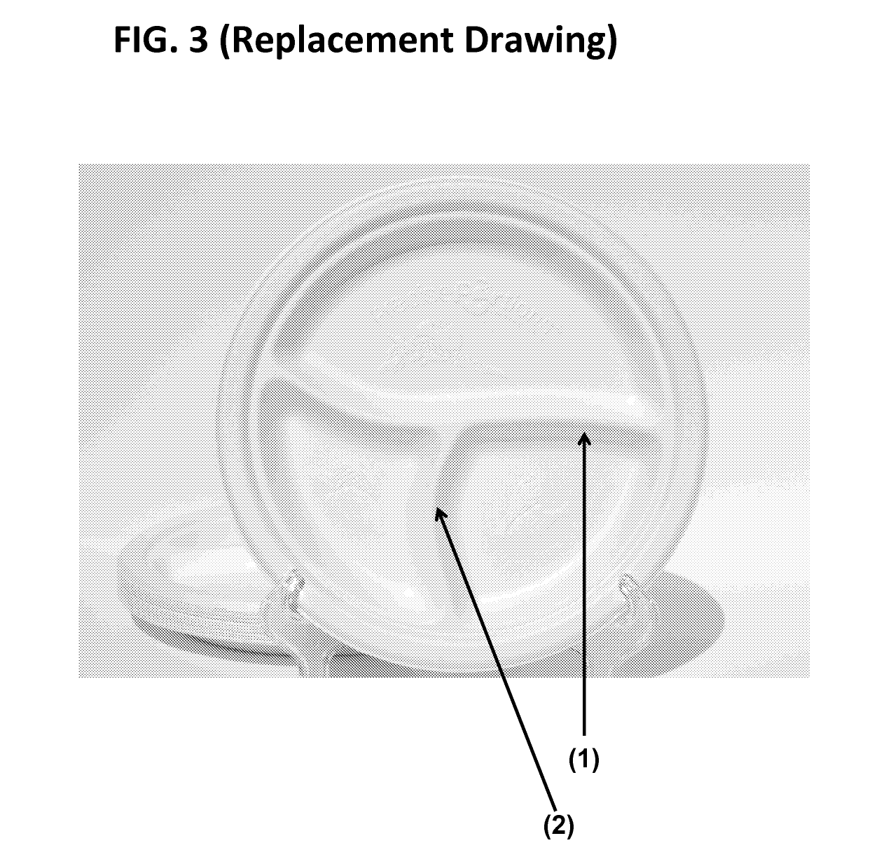

The precise portions living tools include plates, bowls, and beverage glasses, and are the first and only complete dietitian designed portion control place setting that can be both microwave and dishwasher safe. Most competitive products are made of melamine plastic, which is not microwave safe. The plates, bowls, and glasses can be made of porcelain, glass, plastic, tempered glass, ceramic, stoneware, or wood. The plates of the above system can have a size ranging from 4″ to 10″ in diameter (e.g., 4″, 5″, 6″, 7″, 8″, 9″, and 10″). The plate can be transparent. The plate can also have one or more (e.g., 2, 3, or 4) sections divided by protruded walls (FIG. 3 parts (1) and (2)) on the surface of the plate.

The plates, bowls, and beverage glasses are made of a material selected from the group consisting of porcelain, glass, plastic, tempered glass, ceramic, stoneware, and wood.

In preferred embodiments, the said plates, bowls, and beverage glasses can be microwave safe. The plates, bowls, and beverage glasses can also be dishwasher safe.

The plates, bowls, and beverage glasses can be made of a single use disposable material (e.g., Styrofoam, cardboard, compostable sugarcane, compostable bamboo, and paper). The plates, bowls, and beverage glasses can also be made of an eco-friendly single use disposable material.

The bowls to be used in the system can have a capacity ranging from 2 oz to 20 oz, e.g., an 18 oz cereal bowl, and an 8 oz snack bowl. The beverage glass of the system can have a capacity ranging from 2 oz to 15 oz, e.g., a 10.5 oz beverage glass.

The plates, bowls, and glasses can also be made of eco-friendly, 100% compostable paper plates (as illustrated in FIG. 3).

In some embodiments of the present invention, the dishware and discs are packaged in a packaging that has an overview of the entire system, which is designed to enhance the user's experience with the utilization of the system. It can contain all the necessary information on how to use the system of the present invention. Additionally, the system and its components (e.g., plates, bowls, glasses, and discs) can have kid-friendly motifs and indicia to make the system attractive for use by kids. These can include kid-friendly mascots (e.g., Portia and Plato). The system can also include flash cards. The system can also include kids targeted nutrition learning games

The precise portions plating system includes a portion control living tool for each and every part of a person's meal and snacks, no other complete solution such as this exists:

9″ FOCUS plate with dietary guidelines imprinted into the design on the plate itself—designed for both consumer use, and for teaching use, unlike most of the competitive products. These are the “training wheels” that execute the perfect science of the plate method. The measurements are cleverly integrated into the design.

10″ LIFE-style plate is the maintenance tool that continues to reinforce the patterns and behaviors to ensure life-time compliance. Novel in the marketplace, the measurements are cleverly integrated into the design.

6″ bread or dessert plate—makes it all easy to focus on the size of desserts if it fits within a person daily calorie budget. The actual eating well of the plate is 4″. This is the healthy way that consumers should eat.

18 oz cereal Bowl—The ½ cup measurement increments are cleverly integrated into the design of the bowls. Very effective at helping to consistently control the quantity of cereal, soup, salads, etc. consumed.

8 oz snack Bowl—2 oz measurement increments that enable consistent control of the quantity of snacks such as nuts and small particle-sized snacks.

10.5 oz beverage Glass—4 oz measured increments integrated into the design. Especially for people with diabetes who need to carefully manage their intake of sugar, this easily shows where 1 serving of fruit juice should be. No measuring, no guesswork by consumers.

A 9″ 3-section “Go Healthy” Travel Plate with a tight, ventable lid that is microwave safe and perfect for lunch or on the go.

A 4 oz portion control scoop/ladle that helps with serving the right portions instantly and provides another check and balance for consumers. No need to measure, just scoop and serve.

In one embodiment, the plates in the dishware system can be made of a transparent material such that the plate can be placed on one of the precise portions control system discs to guide the user to serve the appropriate amount of each food group onto the plate based on the indicia and nutritional guidelines present on the disc.

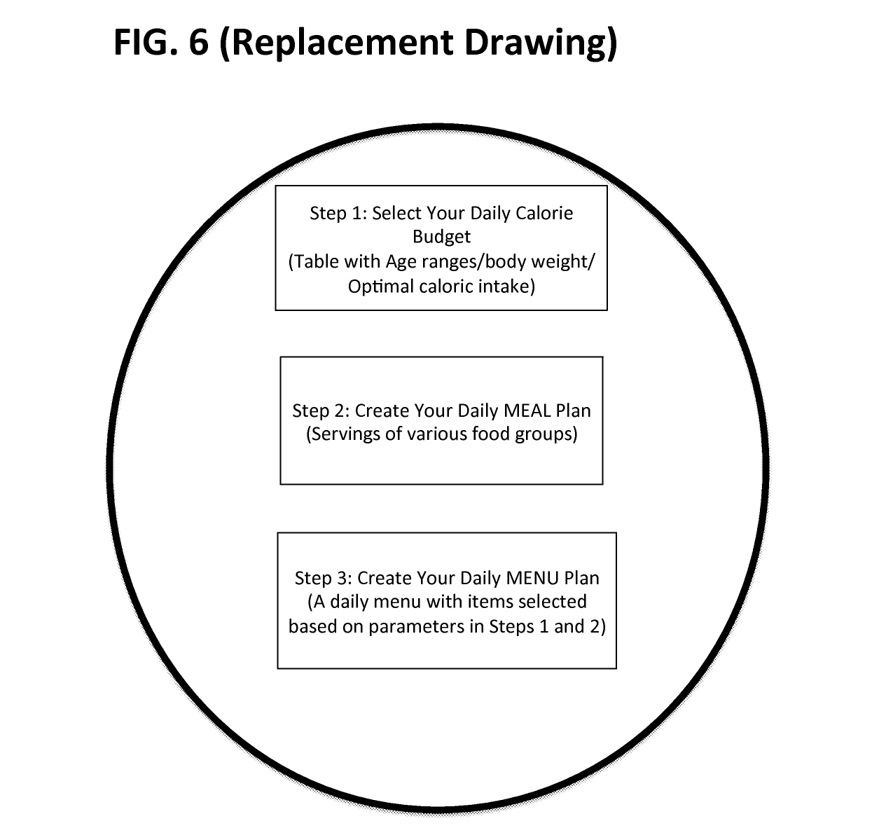

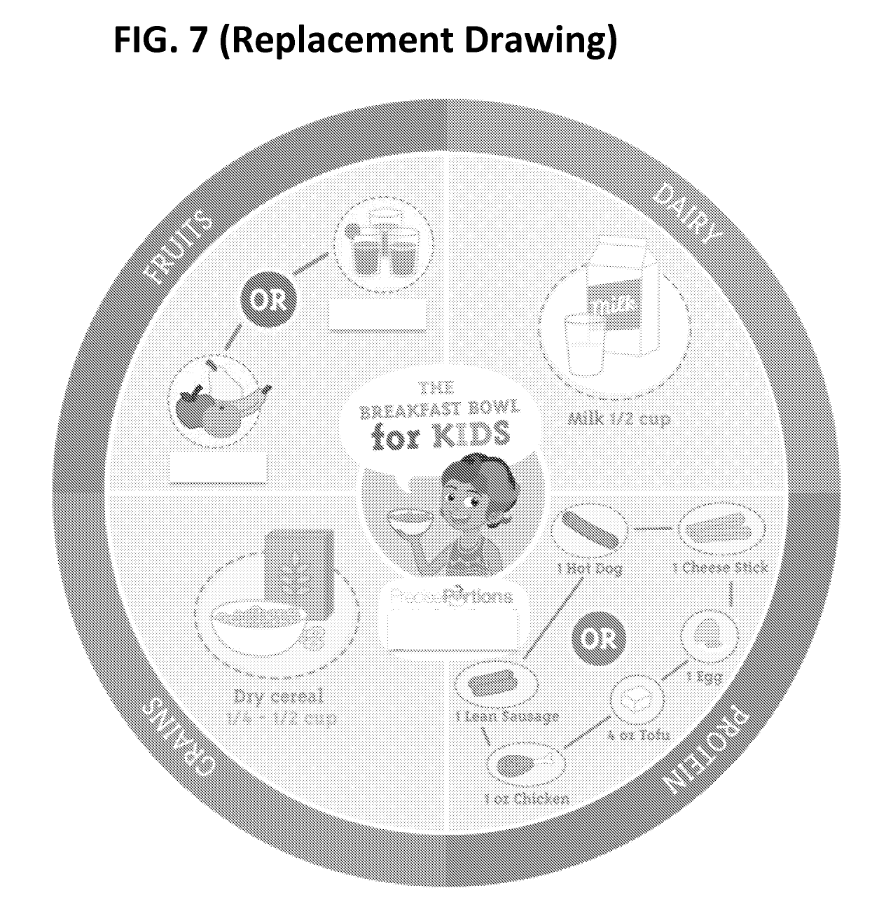

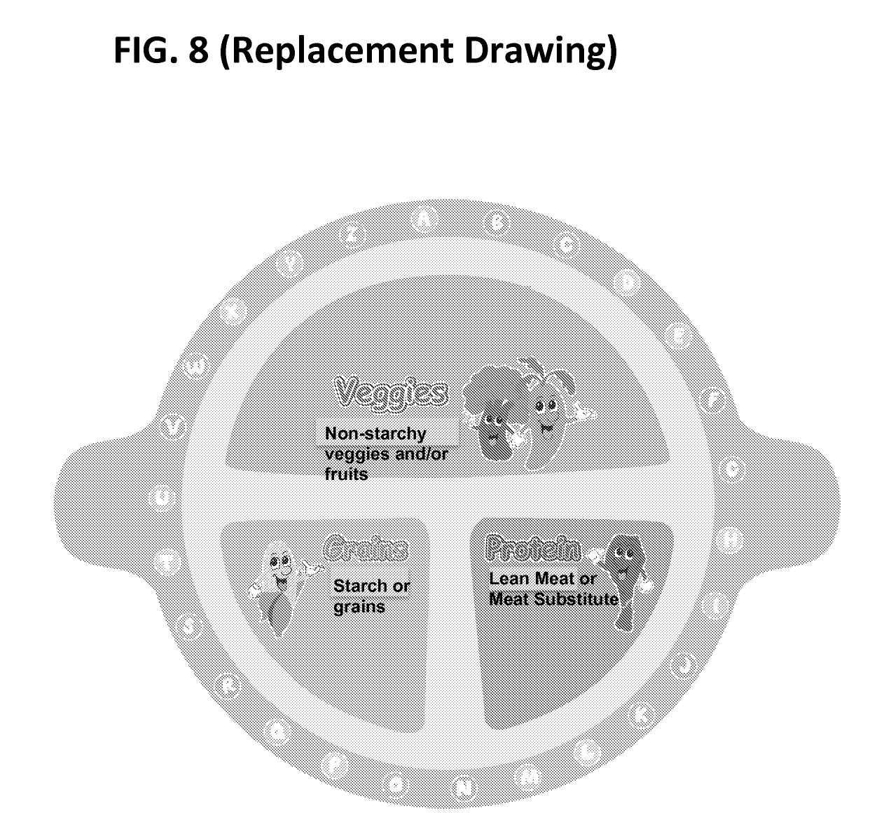

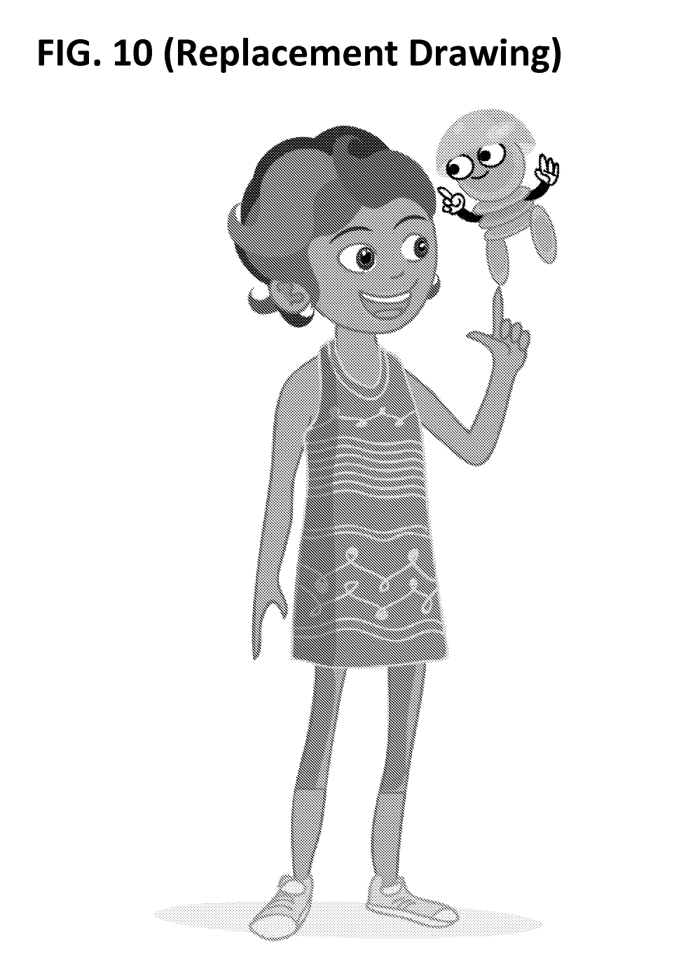

In another embodiment, the dishware and the discs of the system of the present invention can have indicia and motifs that can be used to make them attractive to children (e.g., as shown in FIGS. 6 to 10). In a further embodiment, these indicia and motifs can also contain information or infographics that can be used as educational tools to teach children to consume healthy well-proportioned meals.

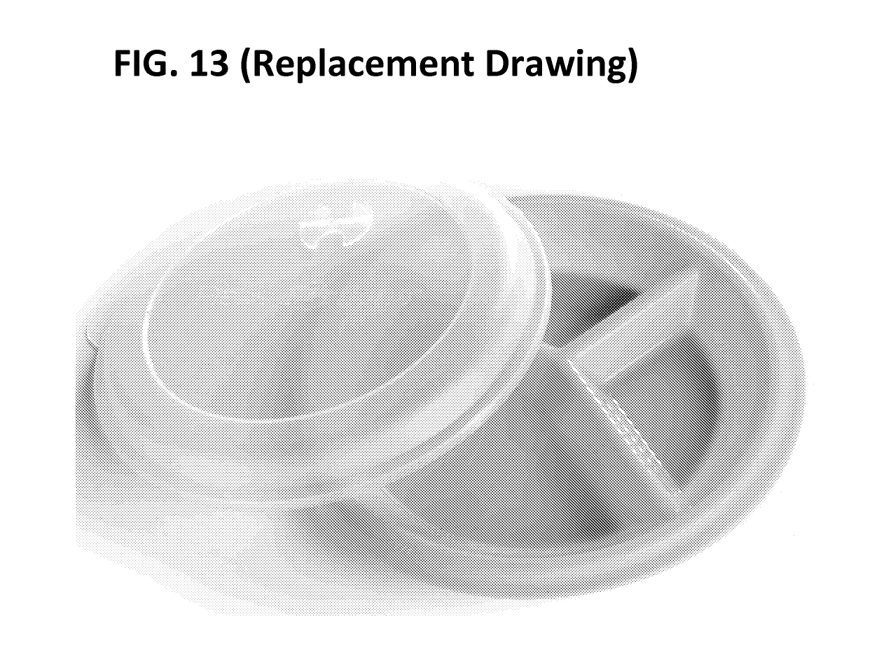

The system can also include a travel system that includes the discs and a divided plate with a ventable lid to fit on top of the plate (FIG. 13). This enables the system to be used during travel or for food to be transported in a lidded plate during travel.

The precise portions nutrition control system discs are new, and are uniquely designed using the latest Infographics best practices. This methodology allows for presenting a lot of data visually. When consumers are given effective nutrition training guidelines using an infographics approach (e.g., as shown in FIGS. 6 to 9), they can get the picture quickly and easily with one look at the visual representations. This ability to easily learn and retrain one's behaviors is further reinforced with the use of valuable, scientific data presented in a very user friendly way.

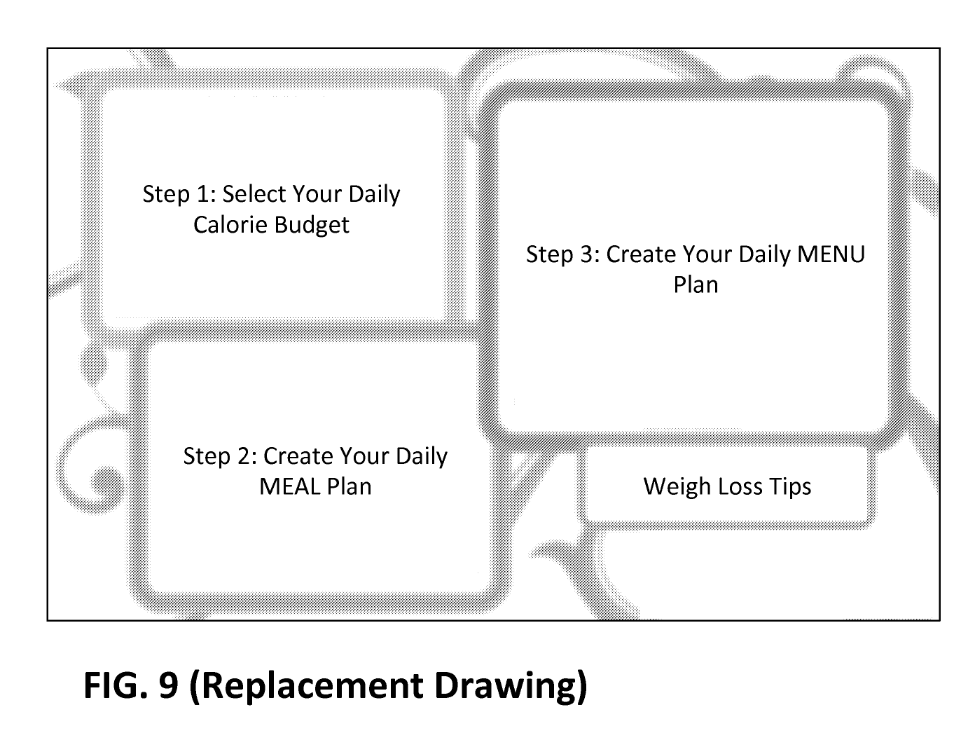

Further, the precise portions nutrition control system discs are presented as a series of varying placemats, as illustrated in FIG. 9, for daily use and are the first of its kind It serves as a both a living tool and a learning tool to retrain the eyes and the brain on how to balance the right portions and proportions of each and every food group; for every meal occasion, including daily snacks.

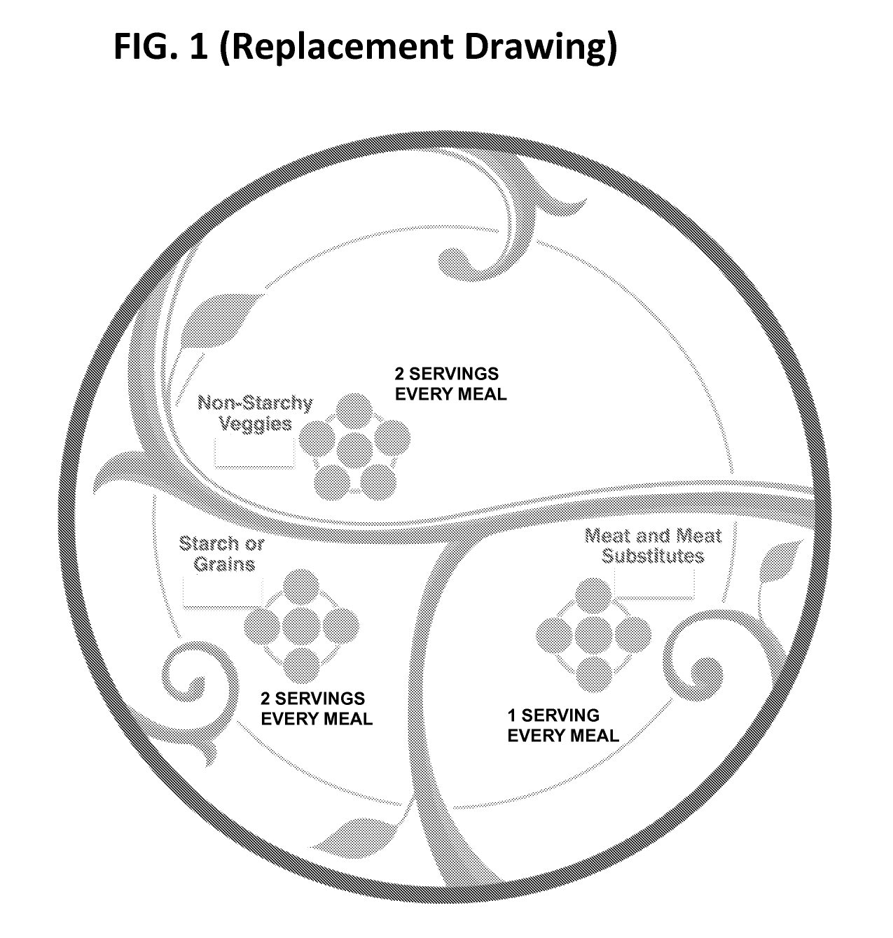

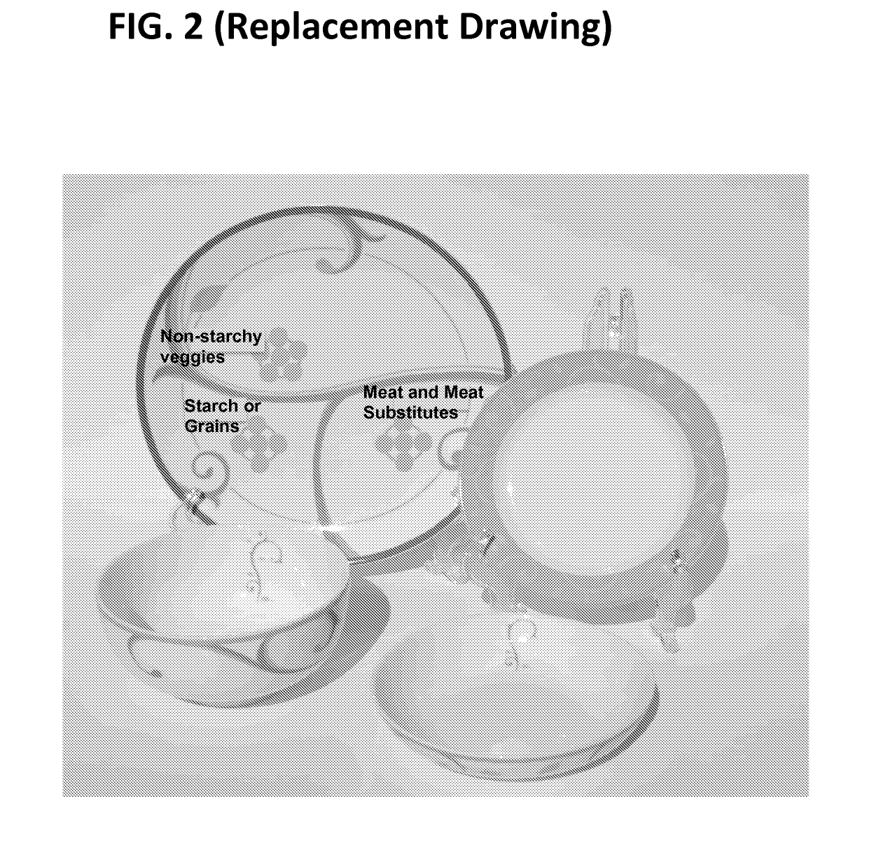

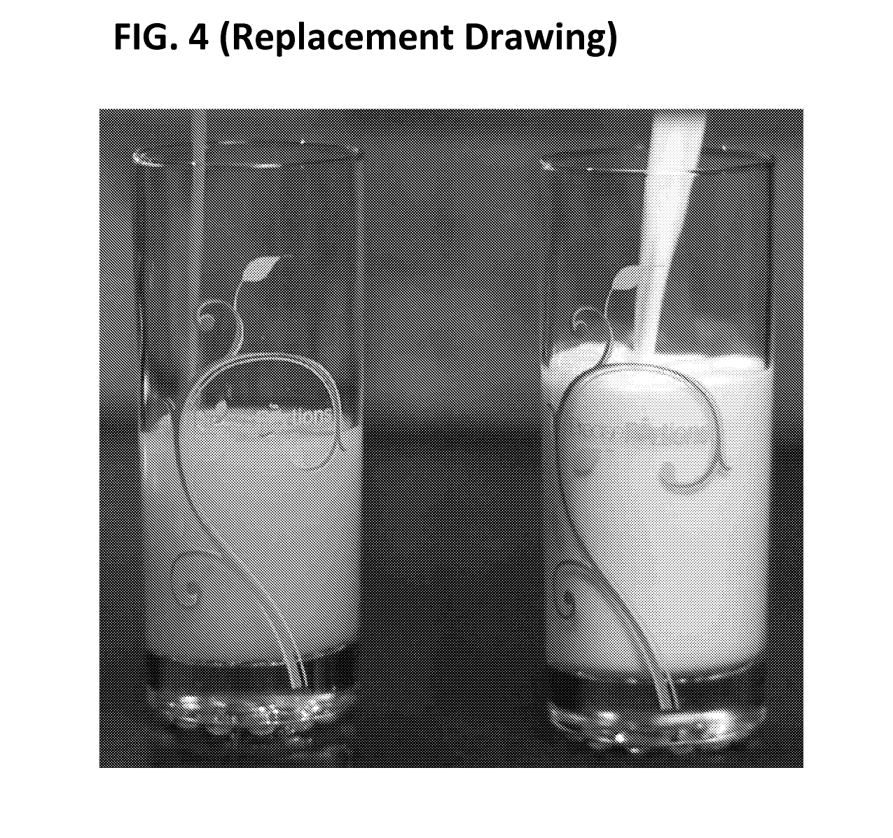

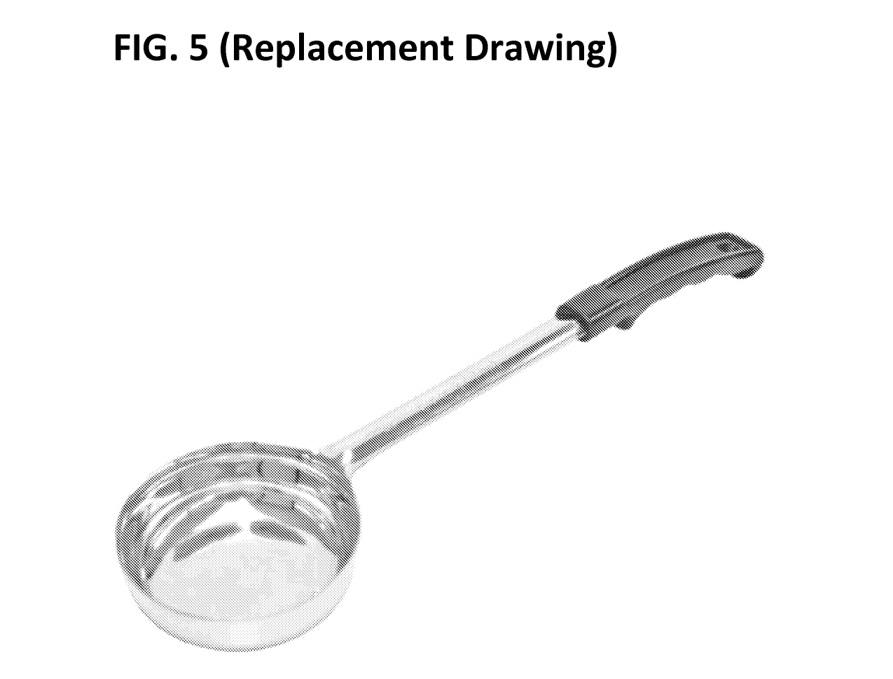

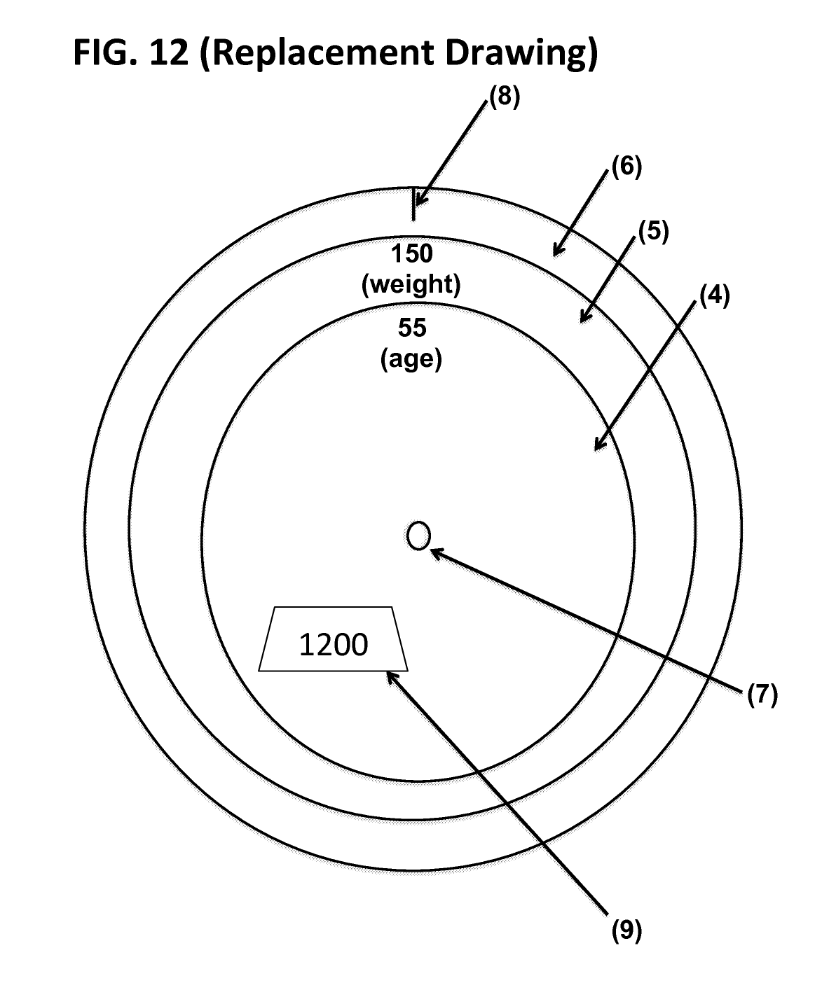

According to some embodiments of the present invention, the discs can be laminated. The discs can be hinged together at one pivotal point, such that they could rotate around the pivot point (FIG. 12, part (7)). There can be two discs, or more than two discs pivotally attached together with a hinge. In some embodiments, the user of the system can place the portion control dishware (shown in FIGS. 1 to 6, and 8) on one of the two disks and read information posted on another disk, the user would need to rotate one of the disks around the pivot point to form a so-called figure eight. In cases where more than two discs are used, the user can rotate one disk around the pivot point to form the figure eight and read the information posted on that disk, while placing the dishware on top of the remaining disks stacked together. The information printed on the discs can be nutrition information that helps the user to utilize the precise portions dishware in accordance with the instructions on the discs (FIGS. 6-8).

In one embodiment, multiple discs, attached by hinges, and encoding different user parameters can be used in a combinatorial manner to calculate caloric intake for a user (FIG. 12). For example, one disc can designate the age of the user, a second disc can designate weight of the user, and a third disc can designate the blood glucose level of a user. Upon alignment of these three parameters at a specific position (e.g., in a straight line) a fourth disc can then show the caloric intake that is optimal for that specific user based on the input parameters of the three discs. In yet another embodiment, the fourth disc can additional also provide information on the food groups that a user can consume to achieve this specific caloric intake providing a user with the dietary guidance that is best suited to their age, weight, and other such biological parameters. Additionally, one of the discs can designate the physical activity level of a user (e.g., inactive, active, or very active) to be used as one of the input parameters to determine optimal caloric intake value for a user. The discs can have alignment marks and windows for visualizing various information. The discs can also be transparent. FIG. 12 illustrates one such exemplary disc where three discs ((4), (5), and (6)) are attached at a central pivotal hinge (7), such that the three discs can be rotated. The first disc (4) contains age information and the second disc (5) contains weight information. When the two are aligned at an alignment mark (8), a window (9) shows the caloric intake optimal for that patient. This calorie information is encoded on a third disc (6). Patients with diabetes, or patients on weight-management programs will benefit immensely from use of such combinatorial discs.

In some instances the size of the discs can be bigger than the size of the plates. For example, the size of the disc can be between 4 to 12 inches in diameter, while the size of the plate can be from 5-10 inches in diameter. In some instances the discs can be made of a transparent material with opaque lettering and information, such that the disc can be placed on dishware of a user's choice, e.g., a plate, to guide the user to determine how much of each food type to place on the plate.

The precise portions nutrition control system discs work in conjunction with the precise portions plating system to create an even more seamlessly integrated system of complete living and learning tools to help improve eating habits and ensure healthier lives & lifestyles. There is no other system like this in the marketplace today; especially one that is used in harmony with a portion control plating system to retrain the brain and the eyes for behavior change. The perfect solution to prevent or effectively manage most diet related chronic diseases.

The precise portions nutrition control system discs can include any one or more of:

a Daily Calorie Budgeting System that enables personalized calorie management;

a Daily Meal Planning method to create balanced Nutrition that uses a person's Daily Calorie Budget to ensure that the System can be uniquely customized for each person's lifestyle and favorite foods;

a Daily Menu Planning Method to create a healthy personalized daily menu plan for each meal occasion, and includes suggested daily snacks to ensure steady blood glucose levels and energy management throughout the day;

a Daily Meal Planning Methods to support eating habits of different cultures, e.g., Native Americans, Latinos, Asians, Caucasians, and African Americans;

a process for proportioning food groups and retraining on how to identify nutrient rich, low calorie foods versus nutrient poor, calorie dense options. The emphasis being on the amount of protein, fats, carbohydrates, fiber, vitamins and mineral, all key components of well balanced nutrition;

a graphical method using Infographics to retrain the eyes by creating visual cues and icons on how create balanced nutrition for breakfast, lunch, dinner and snacks; and

Healthy Eating Menu Plans that can be tailored to individual health goals.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. A system for controlling food portion in a meal for optimal nutritional intake, said system comprising:
a) one or more precise portions living tools selected from the group consisting of one or more plates, one or more bowls, and one or more beverage glasses, wherein said one or more precise portions living tools have indicia on the surface of the tool to provide dietary guidelines for selecting an appropriate portion of a food group; and
b) one or more of a precise portions nutrition control system disc comprising nutritional information for daily calorie budgeting, daily meal planning, infographics for creating balanced nutritional means, or healthy eating menu plans.

2. The system of claim 1, wherein said system further comprises one or more precise portions learning tools selected from the group consisting of an e-book, hard copy books, interactive teaching videos, maintenance programs, and one or more personal coaching systems.

3. The system of claim 3, wherein said plates can be selected from the group consisting of a 6″ plate, a 9″ plate, and a 10″ plate.

4. The system of claim 1, wherein said plate is transparent.

5. The system of claim 1, wherein said plate has one or more sections divided by protruded walls on the surface of the plate.

6. The system of claim 5, wherein said plates, bowls, and beverage glasses are made of a material selected from the group consisting of porcelain, glass, melamine resin, plastic, tempered glass, ceramic, stoneware, and wood.

7. The system of claim 5, wherein said plates, bowls, and beverage glasses are microwave safe.

8. The system of claim 5, wherein said plates, bowls, and beverage glasses are dishwasher safe.

9. The system of claim 1, wherein said plates, bowls, and beverage glasses are made of a single use disposable material.

10. The system of claim 9, wherein said plates, bowls, and beverage glasses are made of an eco-friendly single use disposable material.

11. The system of claim 9, wherein said plates, bowls, and beverage glasses are made of a material selected from the group consisting of Styrofoam, cardboard, compostable sugarcane, compostable bamboo, and paper.

12. The system of claim 1, wherein said bowls can be selected from the group consisting of an 18 oz cereal bowl, and an 8 oz snack bowl.

13. The system of claim 1, wherein said beverage glass is a 10.5 oz beverage glass.

14. The system of claim 1, wherein two or more of said precise portions nutrition control system discs are hinged together at one pivotal point, such that said two or more discs can rotate around said pivotal point.

15. The system of claim 1 further comprising a portion control ladle.

16. A method for proportioning food groups for optimal nutritional intake using the system of claim 1, wherein said method comprises serving specific food groups into one or more precise control portion tools based on the indicia on said surface of said tool to serve the appropriate proportion of specific food groups for optimal nutritional intake.

17. The method of claim 16, wherein said method further comprises placing said plate on one or more of said precise portions nutrition control system discs to serve food on said plate based on the nutritional information on the disc.

18. The method of claim 16, wherein said plate is transparent.

19. The method of claim 16, wherein said method further comprises using a set of precise portions nutrition control system discs attached at a pivotal hinge, wherein said discs encode specific user parameters to determine a caloric intake specific to that user by aligning two or more discs in a specific position such that one of the discs outputs a caloric intake value based on the user parameters encoded in the other discs.

20. The method of claim 19, wherein said user parameters are selected from the group consisting of height, weight, blood glucose level, age, level of physical activity (inactive, active, or very active), and basal metabolic rate.
